(19) United States
(12) Patent Application Publication
(10) Pub. No.: US 2016/0062780 A1
(43) Pub. Date: Mar. 3, 2016

(54) PAUSING VIRTUAL MACHINE BASED ON IDLE STATE

(71) Applicant: Lenovo (Singapore) Pte. Ltd., New Tech Park (SG)

(72) Inventors: Bryan L. Young, Apex, NC (US); Amy Leigh Rose, Chapel Hill, NC (US); Nathan J. Peterson, Durham, NC (US); John Scott Crowe, Durham, NC (US); Jennifer Lee-Baron, Morrisville, NC (US)

(21) Appl. No.: 14/469,885

(22) Filed: Aug. 27, 2014

(51) Int. Cl. G06F 9/455

(52) U.S. Cl. CPC G06F 9/45558; G06F 2009/45575

(57) ABSTRACT

In one aspect, a device includes at least one processor and a memory accessible to the at least one processor. The memory bears instructions executable by the at least one processor to determine that a virtual machine (VM) at the device is in an at least partially idle state and pause the VM in response to the determination that the VM is in an at least partially idle state.

### FIELD

The present application relates generally to pausing a virtual machine operating at a device based on an idle state of the virtual machine.

### BACKGROUND

Virtual machines (VMs) operating on servers are most often always operating and therefore in some instances are unnecessarily consuming things such as e.g. power, processor resources, and hard disk drive resources. When not operating, VMs are in an off state, sleep state, or hibernation state. However, putting VMs in one of these states can lead to instability, and waking VMs from one of these states may take an undesirable amount of time. There are currently no adequate solutions for operating VMs in a reliable and efficient way while not unnecessarily consuming server resources.

### SUMMARY

Accordingly, in one aspect a device includes at least one processor and a memory accessible to the at least one processor. The memory bears instructions executable by the at least one processor to determine that a virtual machine (VM) at the device is in an at least partially idle state, and pause the VM in response to the determination that the VM is in an at least partially idle state.

In another aspect, a method includes identifying that a virtual machine (VM) on a server is in an idle state, pausing the VM in response to identifying that the VM is in the idle state without receiving user input to pause the VM subsequent to the identifying that the VM is in the idle state, and resuming operation of the VM in response to receipt at the server of a signal identified as a signal type for which to resume operation of the VM.

In still another aspect, a computer readable storage medium that is not a carrier wave comprises instructions executable by a processor to determine that a virtual machine (VM) running at a device is not using a processor on the device to perform at least one function, and pause operation of the VM in response to the determination.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIG. 3 is a flow chart showing an example algorithm in accordance with present principles; and

FIGS. 4-6 are example user interfaces (UIs) in accordance with present principles.

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g. smart TVs, Internet-enabled TVs), computers such as desktops, laptops and tablet computers, so-called convertible devices (e.g. having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g. that may not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

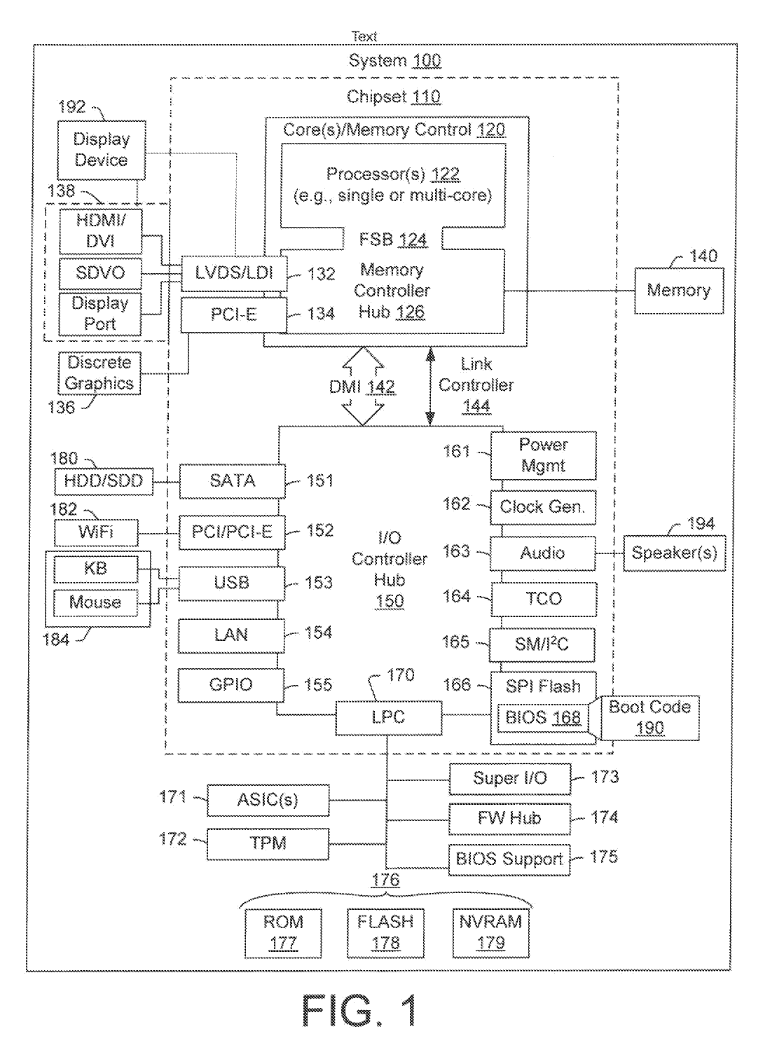

Now specifically in reference to FIG. 1, it shows an example block diagram of an information handling system and/or computer system 100, such as e.g. a server (e.g. an Internet server, a closed-network server, etc.) or a personal computer. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be e.g. a game console such as XBOX® or Playstation®.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including e.g. one of more GPUs). An example system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though now shown for clarity, in some embodiments the system 100 may include a gyroscope for e.g. sensing and/or measuring the orientation of the system 100 and providing input related thereto to the processor 122, an accelerometer for e.g. sensing acceleration and/or movement of the system 100 and providing input related thereto to the processor 122, an audio receiver/microphone providing input to the processor 122 e.g. based on a user providing audible input to the microphone, and a camera for gathering one or more images and providing input related thereto to the processor 122. The camera may be, e.g., a thermal imaging camera, a digital camera such as a webcam, and/or a camera integrated into the system 100 and controllable by the processor 122 to gather pictures/images and/or video. Still further, and also not shown for clarity, the system 100 may include a GPS transceiver that is configured to e.g. receive geographic position information from at least one satellite and provide the information to the processor 122. However, it is to be understood that another suitable position receiver other than a GPS receiver may be used in accordance with present principles to e.g. determine the location of the system 100.

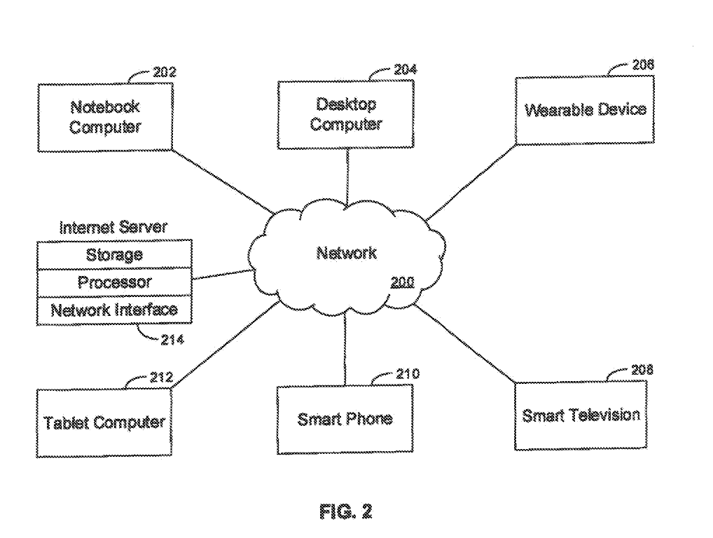

Before moving on to FIG. 2, it is to be understood that an example client device or other machine/computer may include fewer or more features than shown on the system 100 of FIG. 1. In any case, it is to be understood at least based on the foregoing that the system 100 is configured to undertake present principles.

Turning now to FIG. 2, it shows example devices communicating over a network 200 such as e.g. the Internet in accordance with present principles. It is to be understood that e.g. each of the devices described in reference to FIG. 2 may include at least some of the features, components, and/or elements of the system 100 described above. In any case, FIG. 2 shows a notebook computer 202, a desktop computer 204, a wearable device 206 such as e.g. a smart watch, a smart television (TV) 208, a smart phone 210, a tablet computer 212, and a server 214 in accordance with present principles such as e.g. an Internet server that may e.g. provide cloud storage accessible to the devices 202-212. It is to be understood that the devices 202-214 are configured to communicate with each other over the network 200 to undertake present principles.

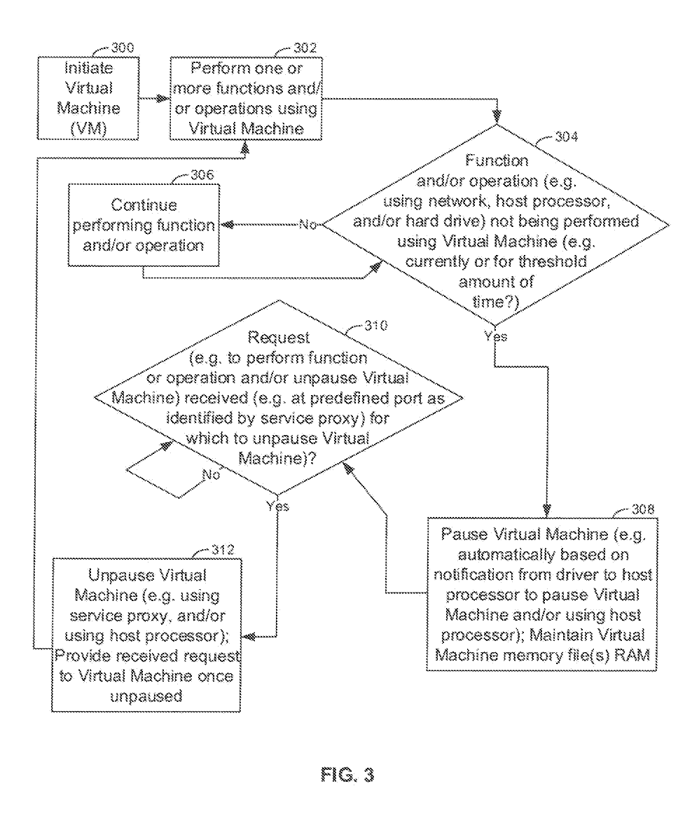

Referring to FIG. 3, it shows example logic that may be undertaken by a device such as the system 100 (e.g. a personal computer, a server, etc.) in accordance with present principles. Beginning at block 300, the logic initiates at the device at least one virtual machine (VM). The logic then proceeds to block 302, at which the logic performs one or more functions and/or operations using the VM (e.g. running applications, using an operating system running thereon to perform a task, browsing the Internet, communicating over a network, storing data in a hard disk drive, etc.). Thereafter, the logic moves to decision diamond 304.

At diamond 304, the logic determines whether one or more functions and/or operations (e.g. such as those involving use of a network over which the device communicates, those involving use of a (e.g. host) processor of the device, and/or those involving use of a hard disk drive (HDD) of the device or other non-volatile storage of the device) are not being performed using the VM (e.g. a determination that less than a threshold amount of HDD resources, processor resources, and/or network resources are being used e.g. for a threshold amount of time). Note that in some embodiments, the determination may be that one or more functions and/or operations (e.g. any function and/operation) are currently (e.g. at the time and/or instant of the determination) not being performed, while in other embodiments the determination may be that one or more functions and/or operations have not been performed for a threshold amount of time. Also note that e.g. the host processor of the device may make such a determination at least in part based on data from e.g. a monitoring utility running at the device which monitors one of more of e.g. network activity, processor activity, and/or HDD activity.

In any case, note that a negative determination at diamond 304 causes the logic to proceed to block 306, at which the logic continues to perform one or more functions and/or operations at the VM. After block 306, the logic may revert back to diamond 304 and proceed therefrom.

Once an affirmative determination is made at diamond 304, the logic moves to block 308. At block 308, the logic pauses the VM e.g. automatically without user input to pause the VM such as subsequent to the determination at diamond 304, and/or such as to make the determination at diamond 304. Regardless, it is to be understood that the logic may pause the VM at block 308 based on a notification from a (e.g. network) driver running at the device to the host processor, where the notification includes an indication and/or instruction for the host processor to pause the VM. However, note that the host processor itself may pause the VM e.g. without the aid of a notification from the driver. Also at block 308, note that because the VM has been paused, at least one memory file for the VM is maintained (e.g. remains resident) in random access memory (RAM) of the device.

Before moving on, it is to be understood that a driver operating in accordance with present principles, such as the one referenced above, may be e.g. a VirtIO driver or another suitable application, mechanism and/or driver for such purposes (e.g. as used by the VM to notify the host processor that the VM is ready and/or prepared to be paused based on e.g. a current amount of network traffic and/or a lack thereof).

Continuing the description of FIG. 3, after the VM is paused and at least one VM memory file is maintained in the device's RAM at block 308, the logic proceeds to decision diamond 310. At diamond 310 the logic determines whether a request and/or network packet has been received e.g. to perform a (e.g. input/output (I/O)) function and/or operation using the VM, and/or to unpause the VM. Note that in some embodiments, the determination may be more specific in that the determination may be whether a request and/or network packet has been received at a predefined port of the device (e.g. port 80 if the device is a server, a port for secure requests as opposed to unsecure requests, etc.) for which requests and/or packets directed thereto are monitored and/or identified by a service proxy (and/or application proxy) for unpausing the VM.

Accordingly, in some embodiments such a service proxy may e.g. monitor network traffic across a network bridge of the device for packets directed to the VM to accordingly determine if and when to unpause the VM. Thus, it is to be understood that in some embodiments requests and packets directed to some ports, and/or requests and packets of some types, may cause the device to unpause the VM, while requests and packets to other ports and/or of other types (e.g. address resolution protocol (ARP) requests) may be processed by the service proxy on behalf of the VM without unpausing the VM to process the request. It is to be further understood that, also in some embodiments, the requests, packets, and/or other network traffic directed to ports for which the VM is not to be unpaused may be ignored, as may be requests, packets, and/or network traffic of types for which the VM is not to be unpaused.

Still in reference to diamond 310, note that a negative determination made thereat causes the logic to continue making the determination at diamond 310 until an affirmative one is made. Once an affirmative determination is made, the logic proceeds to block 312. At block 312 the logic unpauses the VM e.g. using the service proxy, and/or using the host processor (e.g. directly without the assistance of the service proxy). Also at block 312, once the VM has been unpaused, the request(s) and/or packet(s) received which led to the affirmative determination at diamond 310 may be provided and/or forwarded to the VM which has resumed operation. After block 312, the logic may revert back to block 302 e.g. to perform one or more functions and/or operations using the VM based on the received request(s) and/or packet(s).

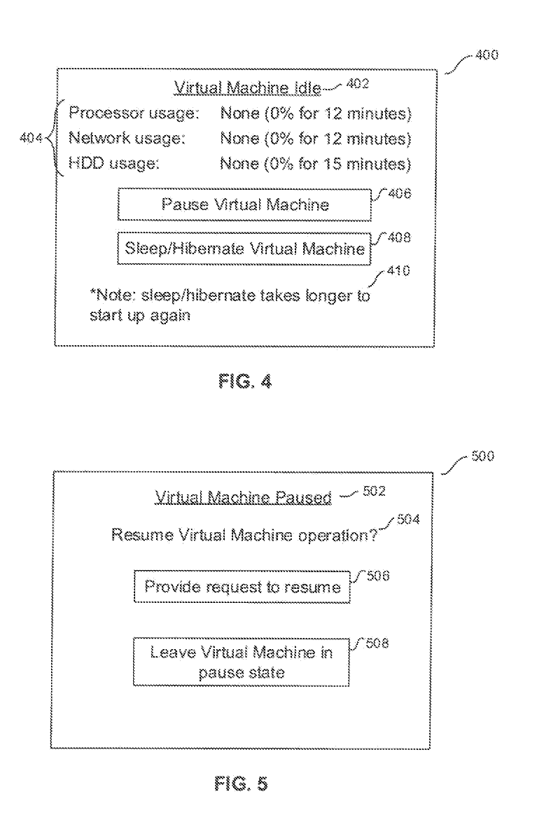

Continuing the detailed description in reference to FIG. 4, it shows an example user interface (UI) 400 that may be presented on a (e.g. touch-enabled) display of a device undertaking present principles (e.g. a device undertaking the logic of FIG. 3, such as a server), and/or may be presented on a display of a different device for configuring another device to undertake present principles. Regardless, the UI 400 includes an indication 402 that a VM to which the UI 400 pertains is idle. The UI 400 also includes one or more indications 404 of activity, such as e.g. current processor activity and/or usage by the VM, current network activity and/or usage by the VM, and/or current HDD activity and/or usage by the VM. Note that in some embodiments the indications 404 may include data pertaining to e.g. the lack of activity and/or usage (e.g., zero percent and/or activity at or below a threshold amount for e.g. a threshold time) of one or more such resources and the amount of time for which the respective resource has not been used.

Still in reference to the UI 400, it may also include a selector element 406 which is selectable to automatically without further user input pause the VM. Another selector element 408 is also shown, which is selectable to automatically without further user input put the VM in a sleep or hibernate state. Also note that beneath the element 408 is an indication 410 that placing the VM in a sleep or hibernate state will cause the VM to take longer to start up again (e.g. relative to instead pausing the VM).

Moving on, reference is made to FIG. 5. FIG. 5 shows an example UI 500 which may be used to unpause a VM. The UI 500 includes an indication 502 that the VM is paused. The UI 500 also includes a prompt 504 for whether to resume VM operation (e.g. unpause the VM). Accordingly, a selector element 506 is included on the UI 500 that is selectable to automatically without further user input unpause the VM, while a selector element 508 is included on the UI 500 that is selectable to automatically without further user input decline to do so and e.g. automatically remove the UI 500 from the display on which it is presented.

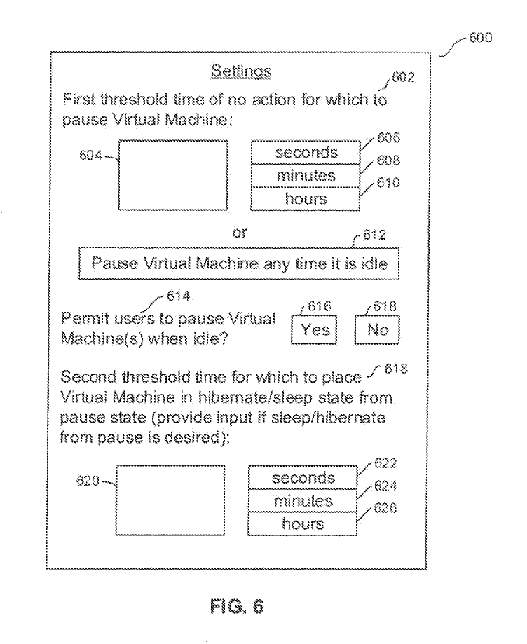

Now in reference to FIG. 6, it shows an example settings UI 600 for e.g. a user and/or VM administrator to configure settings of a device and/or application undertaking present principles. The UI 600 includes a first setting 602 to establish a threshold amount of time of no action, operations, and/or functions being executed at the VM(s) to which the UI 600 pertains, where upon the threshold amount of time being met the VM(s) will be paused. Thus, a text entry box 604 for entering a number is provided on the UI 600, along with respective selector elements 606, 608, and 610 which are selectable to associate a number entered into the box 604 with a time increment of e.g. seconds, minutes, and hours, respectively, to thus establish the first threshold amount of time. Also note that a selector element 612 may be included for the setting 602, where the selector element 612 is selectable to automatically without further user input configure the device to pause the VMs anytime the VMs are idle rather than upon the VMs being idle for a threshold amount of time.

The UI 600 may also include a second setting 614 for whether to permit users to pause VMs when they are idle (e.g. based on a user selecting the element 406 described above). Accordingly, a yes selector element 616 is included which is selectable to automatically without further user input permit users to pause VMs in accordance with present principles, while a no selector element 618 is included which is selectable to automatically without further user input decline to permit users to pause VMs (e.g. while in some embodiments still allowing system administrators to do so).

Still in reference to FIG. 6, the UI 600 may also include yet another setting 618 for establishing a second threshold amount of time, where the second threshold amount of time pertains to placing VMs already in a pause state in a hibernation and/or sleep state from the pause state. Thus, a text entry box 620 for entering a number is provided, along with respective selector elements 622, 624, and 626 that are selectable to associate a number entered into the box 620 with a time increment of e.g. seconds, minutes, and hours, respectively, to thus establish the second threshold amount of time.

Without reference to any particular figure, it is to be understood based on the foregoing that present principles provide for pausing a VM that is idle to thus still maintain a VM memory state file and/or current memory state for the VM in RAM of the device (and e.g. communicatively uncoupling the VM from network(s), the host processor(s) of the device, and/or the HDD(s) of the device) rather than putting the VM in a sleep, hibernate, or off state. However, note that present principles also provide for placing a paused VM in a sleep, hibernate, or off state from the paused state e.g. when a threshold amount of time expires of the VM being in the paused state, and/or upon a user command to do so.

Thus, a device such as a server may run software to automatically and/or dynamically pause a VM (e.g. for a personal computer, upon no user input to the PC, etc.). Pausing the VM will stop it from using CPU resources and/or consuming power, thus e.g. freeing up cores and schedulers of the device for use by other VMs that are operating, as well as the host. To wake a VM up from a pause mode, e.g. a magic packet or other wake up packet intended for the VM's MAC may be intercepted (e.g. by a service proxy) and the VM may be un-paused (e.g. relatively instantaneously). Further, when the VM is idle again, it may be paused again. Determining how and/or when to pause the VM can be done e.g. through an added driver running at the device that “tells” the host that the VM is ready to be paused, and/or done e.g. through the host itself which may monitor the VM and pause it in idle periods.

It may also be appreciated that by pausing a VM as opposed to placing it e.g. in a sleep state, the VM may resume relatively faster from a pause state than a sleep state with less CPU usage and disk I/O than from resuming from a sleep state. An administrator may add RAM as needed to thus “fit” as many VMs as desired onto one device or server owing to the VMs being pausable to thus consume resources when needed while freeing up those resources when not needed.

Furthermore, it is to be understood that in some embodiments a service proxy may be used to un-pause VMs to service requests as needed. The service proxy may reside on the host and may use relatively fewer protocols/communication to implement.

Before concluding, it is to be understood that although e.g. a software application for undertaking present principles may be vended with a device such as the system 100, present principles apply in instances where such an application is e.g. downloaded from a server to a device over a network such as the Internet. Furthermore, present principles apply in instances where e.g. such an application is included on a computer readable storage medium that is being vended and/or provided, where the computer readable storage medium is not a carrier wave and/or a signal per se.

While the particular PAUSING VIRTUAL MACHINE BASED ON IDLE STATE is herein shown and described in detail, it is to be understood that the subject matter which is encompassed by the present application is limited only by the claims.

1. A device, comprising:
at least one processor; and
a memory accessible to the at least one processor and bearing instructions executable by the at least one processor to:
determine that a virtual machine (VM) at the device is in an at least partially idle state;
pause the VM in response to the determination that the VM is in an at least partially idle state; and
present at least one user interface (UI) on a display, the UI including an indication that the VM is idle, the UI also including at least a first selector element selectable to automatically without further user input pause the VM and at least a second selector element selectable to automatically without further user input put the VM in a sleep or hibernate state.

2. The device of claim 1, wherein the instructions are executable to:
determine that the VM is in the at least partially idle state at least in part based on a determination that the VM is not performing at least one operation at any hard disk drive of the device.

3. The device of claim 1, wherein the instructions are executable to:
determine that the VM is in the at least partially idle state at least in part based on a determination that the VM has not been performing at least one operation at any hard disk drive of the device for at least a threshold amount of time.

4. The device of claim 1, wherein the instructions are executable to:
determine that the VM is in the at least partially idle state at least in part based on a determination that the VM is not performing at least one operation at any hard disk drive of the device at the time the determination is made that the VM is not performing at least one operation at any hard disk drive of the device.

5. The device of claim 1, wherein the instructions are executable to:
determine that the VM is in the at least partially idle state at least in part based on a determination that the VM is not using a processor of the device to perform at least one operation.

6. The device of claim 1, wherein the instructions are executable to:
determine that the VM is in the at least partially idle state at least in part based on a determination that the VM has not been using a processor of the device to perform at least one operation for at least a threshold amount of time.

7. The device of claim 1, wherein the instructions are executable to:
determine that the VM is in the at least partially idle state at least in part based on a determination that the VM is not using a processor of the device to perform at least one operation at the time the determination is made that the VM is not using a processor of the device to perform at least one operation.

8. The device of claim 1, wherein the pause of the VM is a pause that does not comprise the VM being in one of the group consisting of: a sleep state, hibernate state, an off state, a power off state.

9. The device of claim 1, wherein the instructions are executable to:
during pause of the VM, maintain a virtual machine memory file for the VM in random access memory (RAM) of the device.

10. The device of claim 1, wherein the instructions are further executable to:
unpause the VM in response to receipt at the device of a request.

11. The device of claim 10, wherein the request is received at a predefined port for which the VM is to be unpaused in response to receipt of the request at the predefined port.

12. The device of claim 10, wherein the request is an unpause request.

13. The device of claim 10, wherein the request is a request to perform an input/output (I/O) operation which uses the VM.

14. The device of claim 11, wherein the request is identified by a service proxy operating at the device, and wherein the service proxy unpauses the VM in response to receipt of the request.

15. A method, comprising:
identifying that a virtual machine (VM) on a server is in an idle state;
pausing the VM in response to identifying that the VM is in the idle state without receiving user input to pause the VM subsequent to the identifying that the VM is in the idle state;
resuming operation of the VM in response to receipt at the server of a signal identified as a signal type for which to resume operation of the VM; and
presenting on a display at least one user interface (UI), the UI including an indication that the VM is paused, the UI including at least a first selector element selectable to automatically without further user input unpause the VM, and a second selector element selectable to automatically without further user input decline to unpause the VM.

16. The method of claim 15, comprising:
operating a driver at the server which identifies that the VM is in an idle state and notifies a host processor on the server that the VM is to be paused.

17. The method of claim 15, comprising:
pausing, without the aid of a driver, the VM using a host processor of the server.

18. A computer readable storage medium that is not a carrier wave, the computer readable storage medium comprising instructions executable by a processor to:
determine that a virtual machine (VM) running at a device is not using a processor on the device to perform at least one function;
pause operation of the VM in response to the determination; and
present on a display at least one user interface (UI), the UI including at least a first setting to establish a threshold amount of time of no action, operations, and/or functions being executed at the VM such that upon the threshold amount of time being met the VM is paused, the UI including a first selector selectable to cause an automatic pause of the VM when the VM is idle and a second selector to decline to permit a user to pause the VM, the UI further including a second setting for establishing a second threshold amount of time, wherein the second threshold amount of time pertains to placing the VM when already in a pause state in a hibernation and/or sleep state from the pause state responsive to determining that the VM has been paused for the second threshold amount of time.

19. The computer readable storage medium of claim 18, wherein operation of the VM is paused at least in part using an application running on the device that is separate from the VM.

20. The computer readable storage medium of claim 18, wherein the instructions are further executable to:
operate a service proxy to make a determination that a request has been received at the device to perform a function at least in part using the VM; and
operate the service proxy to resume operation of the VM.
